(19) United States
(12) Patent Application Publication
(10) Pub. No.: US 2009/0222305 A1
(43) Pub. Date: Sep. 3, 2009

(54) Shopper Communication with Scaled Emotional State

(76) Inventor: Charles John Berg, JR., Wyoming, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/041,199

(22) Filed: Mar. 3, 2008

(51) Int. Cl. G06Q 30/00

(52) U.S. Cl. 705/7

(57) ABSTRACT

A shopper communication regarding a product or service includes a scaled emotional state. The scaled emotional state is associated with use of the product or service. The scaled emotional state may be in the form of text, a graphical indicia, or a verbal description.

### FIELD OF THE INVENTION

Shopper communications include an indicia analogous to a scaled emotional state, or element thereof, and relate to the field of product marketing. The communication relates particularly to the field of consumer products marketing.

### BACKGROUND OF THE INVENTION

A mammal may undergo a physiological response to stimulus or stimuli. The physiological response may include an emotional component by which the stimulus is interpreted in view of the mammal's prior experiences and/or observations. The emotional interpretation of the physiological changes may result in an altered state of feeling by the mammal and an altered emotional state or emotional response to the stimuli.

Collecting data regarding an emotional response associated with the use of a product or service is known in the art. Data associated with physiological responses to product or service use may be collected and measured in a variety of ways. There are known correlations between particular physiological responses and emotional states. It is possible to correlate physiological response to alterations in emotional state. It is possible also to correlate physiological response to the degree of emotional response.

This data may be used by a marketer to determine which of a number of alternatives available to place into the market. The data may be used to determine which product formula to pursue. The data may be stored in a data base and subjected to queries by interested parties.

What is desired is an avenue for communicating this type of information in a meaningful form to a shopper. The information may be used by the shopper to differentiate one product or service offering from another. The information may assist the shopper in making a purchase decision.

### SUMMARY OF THE INVENTION

In one embodiment a shopper communication regarding a product or service comprises an indicia analogous to a scaled emotional state, or element thereof. The scaled emotional state, or element thereof, is associated with use of the product or service.

In one embodiment a method of communicating information regarding an emotional state, or element thereof, associated with the use of a product or service, comprises observing a physiological state in the user of a product or service, or in an observer of the user, associating the physiological change with an emotional state, or element thereof, deriving a scale of the emotional state, or element thereof, associated with use, determining a value for the associated emotional state, or element thereof, on the derived scale of the emotional state, or element thereof, and communicating the scaled emotional state, or element thereof, via an indicia in an advertisement, as part of the product itself, or as part of a product package.

In one embodiment a product package comprises indicia analogous to a scaled emotional state, or element thereof, derived from the use of the product. In any embodiment, the indicia may be accompanied by marketing terms and/or observed physiological data also related to the use of the product.

### BRIEF DESCRIPTION OF THE DRAWINGS

The above and other advantages and features of the invention will be more clearly understood from the following detailed description which is provided in connection with the accompanying drawings.

FIG. 1 schematically illustrates one embodiment of the invention.

FIG. 2 schematically illustrates an embodiment of the invention.

### DETAILED DESCRIPTION OF THE INVENTION

As used herein, a “scaled emotional state, or element thereof”, relates to an emotional state, or to a feeling which comprises a portion, or element, of an emotional state, which has been associated with a derived value scale. The derived value scale provides a gradation means for relating in a relative manner a level of the emotional state, or element thereof. The value scale may be derived by associating data related to a physiological marker or combinations of physiological markers with gradations of the level of the associated emotional state, or element thereof. “Scaled emotional state, or element thereof”, “scaled emotional state”, “emotional state scale” and “emotional scale” are used interchangeably to convey the full scope of this definition.

As used herein, “packaging” means a structure or material that is at least partially disposed on or about a consumer product when the product is presented to the public. “Primary packaging” means any container, including its closure, pump, cap or other peripheral items, in which the consumer product is in direct contact. And “secondary packaging” means any additional materials that are associated with the primary packaging, such as, for example, a container such as a box or polymeric sleeve that at least partially surrounds, contains, or contacts the primary packaging.

Both the primary and secondary packaging can be made from a variety of materials, can be made in numerous configurations, and can be made with any manufacturing techniques known to the skilled artisan. Exemplary packaging embodiments include boxes, bags, pouches, paperboard cans, bottles, tottles, jars, thermoform blisters, clamshells, and combinations thereof. Other packaging embodiments are equally suitable. A label can be completely or partially affixed to packaging of the product after the packaging is formed or during its formation (e.g., in-mold labeling). The label can be removable (e.g., peelable), and in some embodiments can be reaffixed to the consumer product or its packaging, or affixed to another substrate. In some cases, it may be desirable that the removal step be done with little or no damage (e.g., no unintended distortion, tears, etc) to the label; and/or, the consumer product, advertisement material or packaging to which it was previously affixed. Separately, a label can be completely or partially affixed to the product. The packaging of the labeled product may also have a label that is completely or partially affixed to packaging of the product.

A marketer, manufacturer, retailer, distributor or other purveyor of products and services may select a scaled emotional state to communicate to shoppers in the category of products and services they offer. The scaled emotional state may be provided to the shopper in a communication directed at educating the shopper regarding the particular product or service with an intention of increasing the likelihood of the shopper selecting the product or service. A product or service can comprise and/or include the use of consumable materials and compositions; or, disposable, semi-durable or durable objects such as devices, implements, appliances, or tools.

The term “consumer(s)” is used in the broadest sense and is a mammal, usually human, that includes but is not limited to a shopper, user, beneficiary, or an observer or viewer of products or services by at least one physiological sense such as visually by magazines, a sign, virtual, TV, or, auditory by music, speech, white noise, or olfactory by smell, scent, insult; or, by tactile, among others. A consumer can also be involved in a test (real world or simulation) whereas they may also be called a test panelist or panelist. In one embodiment, the consumer is an observer of another person who is using the product or service. In one embodiment the consumer is an observer of another person who has previously used the product or service. In this embodiment, the consumer is observing the user after a lapse of time or after an exposure of the user to environmental factors. The product or service may be used to clean, condition, or otherwise alter skin, hair, teeth, or specific body portions such as a user's hands and face.

In one embodiment, the consumer may be an observer of an object, area, or mammal which has been subject to the use of the product or service, either immediately following the use or after the lapse of a time period or exposure to environmental factors. In this embodiment, the product or service may be used to clean or condition an object, surface or area.

Environmental factors in such embodiments may include light, heat, smoke, food odors, humidity, precipitation, insects, foreign materials, both liquid and solid, physical wear, weather and weathering and combinations thereof. The observation may be by way of viewing in-person or via photograph, video or simulation. The simulation may be based on actual results or upon projected results based on a previously determined simulation model.

The term “use” or “using” can involve the physical involvement with the good or service, or simply the continued impact or effect after physical involvement. For example, a use of a fragranced, hair-body-resuscitating shampoo product illustrates several “use” situations according to this invention. One use situation is during the application of the shampoo to the hair such as in a shower and having an emotional response or element of one. Another is the consumer's later sensing of the deposited fragrance and having an emotional response or element of one. Another is when the consumer views the improved hair body in the mirror and has an emotional response or element of one. Beyond the applicant herself, there can be other users. A second person can observe the consumer's resultant hair body and have an emotional response or element of one. A third person can smell some of the volatilizing fragrance from the consumer and have an emotional response or element of one. Another can observe the physical involvement or application of a product or service by another person or mammal and have an emotional response or element of one. Any or all of these can be communicated to the shopper by the indicia and methods of this invention.

The term “shopper” is used in the broadest sense and refers to an individual who is considering the selection or purchase of a product for immediate or future use by themselves or someone else. The shopper can also be a likely prospect or a member of a group of prospects, as identified by the marketer, for future purchase or use of a product or service. A shopper may engage in comparisons between products or between services or combinations thereof. A shopper can receive information and impressions by various methods. Visual methods may include but are not limited to the product or its package within a retail store, a picture or description of a product or package, or the described or imaged usage or benefits of a product on a website; electronic or electrical media such as television, videos, illuminated panels & billboards & displays; or, printed forms such as ads or information on billboards, posters, displays, “Point-of-purchase” POP materials, coupons, flyers, signage, banners, magazine or newspaper pages or inserts, circulars, mailers, etc. A shopper sometimes is introduced into a shopping mode without prior planning or decision to do so such as with television program commercials, product placement within feature films, etc. For brevity, the shopper/consumer/panelist may be referred to as “she” for efficiency but will collectively include both female and male shoppers/consumers/and panelists.

The terms “physiological state” and “physiological marker” refer to a measure of a physiological or biological process or state of a human or mammal which is believed to be linked to or influenced at least in part by the emotional state of the human or mammal at a point, or over a period of time. It can also be linked or influenced to just one of the internal feelings at a point or period in time even if multiple internal feelings are present; or, it can be linked to any combination of present feelings. Additionally, the amount of impact or weighting that a given feeling influences an emotional state can vary from person-to-person or other situational factors, e.g., the person is experiencing hunger, to even environmental factors such as room temperature.

The term “emotional state” refers to the collection of internal feelings of the consumer at a point or over a period of time. It should be appreciated that multiple feelings can be present such as anxiousness and fear, or anxiousness and delight, among others. “Emotional state” is considered to include the respective elements which comprise an emotional state. The feelings can also be present in different degrees such as a low or high level of anxiousness, or a mild or intense level of delight.

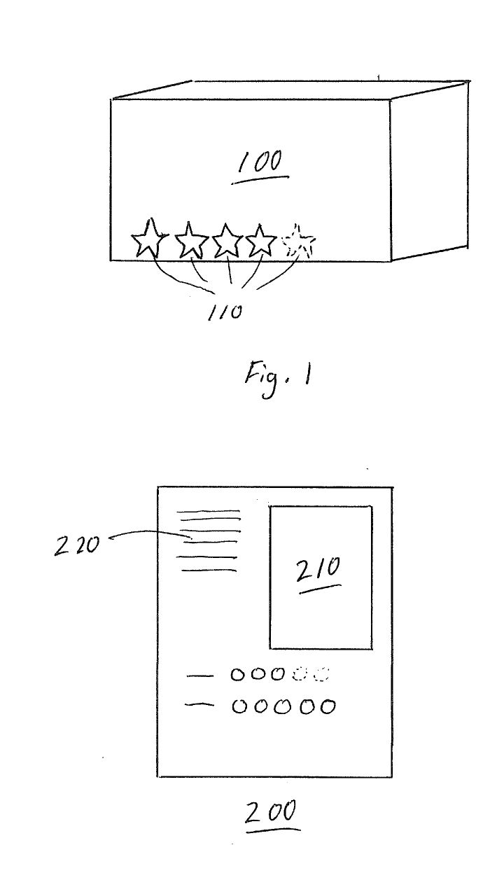

As provided in FIG. 1, a shopper communication regarding a product or service. The communication may comprise primary, secondary, or other levels of product packaging. The communication may be printed upon the package or upon the product itself, upon a label which is affixed to the package or the product itself. The communication may comprise a portion of product or service advertising in any or all known forms. Exemplary forms of advertising include, print, audio, video, product placement, and other electronic media forms of advertising. FIG. 2 illustrates an embodiment of the invention wherein the communication comprises a print advertisement.

The communication comprises an indicia analogous to a scaled emotional state. The indicia may be in any form recognizable by a shopper. The indicia may be presented visually, tactilely, or may be described aurally, where such indicia can for example be received by or exposed to the shopper by any of the classic human senses of sight, touch or hearing. The indicia is analogous to the scaled emotional state and the degree of analogy may vary. Indicia may be directly analogous to the scaled emotional state. In one embodiment, the indicia may provide an indication of user happiness by employing or providing an icon associated directly with happiness. The indicia may be directly associated with the nature of the emotion measured. In one embodiment, the indicia may be less directly analogous to the scaled emotional state. In this example, a simple indicia providing an indication of the relative level of the emotional state via a position upon a scale of gradations may be employed. In one embodiment the indicia may indicate that the emotional state associated with use of the particular product or service reaches a scaled level of 4.5 of a possible 5. The indicia may be a textual description of the scaled emotional state in absolute or relative terms. The shopper communication may comprise multiple indicia or indicia types.

The scaled emotional state provides a measurement of a predetermined emotional state in association with the use of a product or service by the subject, or for the benefit of the subject. The use of the product or service may comprise exposure to sights, sounds, odors, tactile stimuli, as well as auditory stimuli. The use may comprise all or part of a regimen, or a sequence of physical tasks possibly requiring fine or larger motor muscle movements as well as possibly “eye-hand” coordination judgment and execution. The scaled emotional state may also be derived by determining the emotional state of an observer of a use of the product or service by or for the benefit of another entity. The observed use may be with or without direct exposure to the same stimuli as the observed user or beneficiary of the product or service. The emotional response of the observer may thus be based upon either the combination of observing the direct user and the sounds and smells associated with use, or upon the observation of the user alone.

In one embodiment the scaled emotional state may be related to the use of the product or service by a particular preselected individual mammal of a group of mammals. In one embodiment the preselected mammal may be recognized as a spokes-mammal for a product or service or may through appropriate information sources become recognized as such a spokes-mammal.

The scaled emotional state data may be collected from an individual or group of individuals selected randomly to use the product or service. The individual, or group, may be selected using known screening tools to capture data relating to use by shoppers in a target market segment. In this embodiment, the data is derived from product or service users similarly situated, such as having similar needs, desires and characteristics as the target shopper for whom the communication is intended. In one embodiment the scaled emotional state may be derived from the use, or the observation of the use of the product or service by a person, or other entity, associated with products or services of the type for which the communication is intended. In this embodiment, the scaled emotional state may be perceived as derived from a professional or more expert source to whom the target shopper may look for guidance. In this embodiment, the scaled emotional state may be derived from an individual, or group of individuals, with whom use of the class of products or services is associated, by vocation, or avocation In one embodiment the individual, or group of users, may be associated with the product or service by way of their profession. In one embodiment the scaled emotional state may be accompanied in the communication by an endorsement of the product or service by an individual or group from whom the scaled emotional state data has been at least partially derived.

Data for deriving the scaled emotional state may be collected at time frames, prior to use, prior to contemplating use, while contemplating use, during use, near term after use, and long term after use. The multiple time frames enable a comparison of the physiological marker and associated emotional state for the respective interactive states or interactions with the product or service. Data may be collected in association with the use of multiple optional variations, or multiple generations of a single product or service offering, or with competing product or service offerings. Data may be collected during task performance by a subject using “their” or other, third party, methods and alternatively using a method incorporating the subject product or service. Comparatively graded performance data may be communicated to the shopper regarding competing products or an improvement in performance over an earlier version of a branded product. Data may be collected by humans, such as trained observers or researchers, or by automated means, apparatus or any other means or combination thereof.

The indicia may be related directly to the scaled physiological data or to the derived scaled emotional state. The derived scaled emotional state may be derived using known associations between physiological markers and emotional states, or the scale may be created to provide the shopper with a previously unconsidered association between physiological markers and emotional states. The scaled emotional state may also incorporate data relating to use subject demographics and also to environmental factors relating to either the user, the use, or combinations thereof.

Any known scaled emotional state may be used in the communication. Methods found in U.S. Pat. No. 6,830,755, granted to Librizzi, et al., and in U.S. Pat. Nos. 7,213,600B2 and 7,249,603, granted to El-Nokaly, et al., may be used to derive a scaled emotional state from observed physiological data and/or to derive scaled physiological data. The associations contained in these and similar references may be used as well.

A scaled emotional state may be derived via the following steps: measure a physiological state of a user of a product or service, or an observer of the user; associate the physiological state with an emotional state; derive a scale associating a level of the emotional state with a level of physiological state response to use; determine a value for a particular associated emotional state to use of the particular product or service, on the derived scale of the emotional state. The measure can be just at one point in time (e.g. in mid-use or at end of use), or multiple times during use, or multiple times such as prior to use then during use for a comparison, or multiple times with multiple products, (such as a measure for use of different products or services for comparison purposes).

As an example, there further can be any combination of one or more of the following steps in measuring a consumer's emotional state. These steps may include any of: (1) providing at least one stimulus to a consumer; whereas the stimulus may be visual, tactile, aural, olfactory, gustatory or combinations thereof, the stimulus being associated with the actual or observed use of the product or service; (2) measuring and recording the movement of at least one eye of the consumer; (3) measuring at least one physiological element from the consumer; and (4) determining the emotive state, or element thereof, of the consumer by comparing the measured data with a pre-determined model or database of probable emotive states. The determined emotional state may then be used as input in deriving a scaled emotional state value associated with the use of the product or service.

It should be appreciated that a plurality of stimuli could be applied, sequentially, or all at once. Each time a new stimulus is introduced and/or changed, the consumer's physiological response is monitored and captured. A visual stimulus can be viewed by the consumer on a computer monitor, plasma screen, LCD screen, CRT, projection screen, fogscreen, water screen, or any other structure, e.g., imaging apparatus, that allows a real or virtual image to be displayed. A visual stimulus can also be a physical representation. Similarly, the tactile, aural, olfactory and gustatory stimuli may be provided in any manner suited to the use of the product or service under consideration.

The physiological state may be associated with a property or function of the skin, or any of the circulatory, digestive, lymphatic, respiratory, reproductive, skeletal, muscular, excretory, endocrine, or nervous systems, including brain function, or paralanguage of a mammal, alone or in combination. The physiological state may also be associated with paralanguage which can include body language and voice inflection—which are a response to muscular and micro-muscular movements and conditions. The physiological response may be measured using the methods and equipment for making such measurements as are known in the art. The scaled emotional state may be derived utilizing the methods described in U.S. patent application Ser. No. 11/851,638. Additionally, exemplary methods for deriving a scaled emotional state include skin galvanic response, pulse and blood pressure measurement, respiration rate, facial expression, and layered voice analysis.

The methods and equipment for making such measures can involve consumers, panelists etc whereas the measures or measures can involve one or more different categories of equipment types & methodologies such as non-contact, contact and sampling approaches. These can happen in real-life or test conditions. Non-contact approaches have no sensor or other measuring aid in contact with the consumer's body. Examples include IR reflectance of pupil size, saccade paths, or eyelid blink behavior; remote-positioned microphone for voice capture; visual observation or video capture of facial expressions or body language; voice capture and analysis; skin temperature or coloration via for example thermography; heart rate or respiration function by radar and/or Doppler-based analysis means as provided in: WO 20071143535 entitled APPARATUS, SYSTEM, AND METHOD FOR MONITORING PHYSIOLOGICAL SIGNS; and, WO 20071148865 entitled METHOD FOR RADIO PHYSIOLOGICAL SIGNAL BIOMETRIC AND RADIO PHYSIOLOGICAL SIGNAL SYSTEM AND USING THE SAME.

Contact approaches have at least one sensor or other measuring aid in contact with the consumer's body. Examples include: ocular measuring glasses measuring pupil size, saccade paths, or eyelid blink behavior; microphone for voice capture; skin temperature sensor; blood pulse sensor; respiratory rate sensor; galvanic skin sensor; EEG (electroencephalograph) equipment such as in helmet form for measuring brain activity; EMG (electromyogram) muscle and muscle set sensors used to detect movement or tension of muscles such as facial muscles; ECG or EKG (electrocardiogram) to measure cardio electrical signals; sound wave techniques such as echocardiogram to produce or capture images of the heart; etc. Such sensors can be tethered to other equipment or data loggers, or transmit data or information by wireless means such as electromagnetic waves including common IR, “Bluetooth” and other transmission means and wavelengths. Such sensors can also contain data logging or analysis functionality, either as a part of a contact sensor or connected via wires or wireless to another piece of equipment contacting the body.

Sampling approaches indicate that a physical sample is analyzed (sometimes separated or removed from the body) for physiological changes in body tissue or chemistry. Examples of known approaches include the collection of saliva or blood for cortisol stress hormone quantization.

The methods and equipment for making such measures can be performed and used with or without the knowledge of the consumer or panelist. Use of the equipment and methods with the consent of the subject, but without real time knowledge as to the use, may provide data which is free of any attempt by the subject to manipulate the results, or any “white coat syndrome” effects.

Once the scaled emotional state is derived, it may subsequently be communicated to a shopper via an indicia in an advertisement, as part of the product itself, as part of a product package, or as part of a presentation environment such as a retail environment, electronically or via a print medium. It may be communicated to the shopper by itself or in conjunction with other information. Exemplary information includes product performance information as well as product endorsements and other information as is known in the art. The communication may provide a graded value of the scaled emotional state as derived, or may provide a relative performance indication with regard to the scaled emotional state and a plurality of products from a common product segment.

In one embodiment a scaled emotional state may be communicated as discussed for two or more brands in a common category. In this embodiment, the communication may provide the shopper with a point of reference for selecting among brand offerings of either products or services. The scaled emotional state communications may utilize the same indicia and scale range for the purpose of easing the comparison. As an example, two or more brands may each provide a communication comprising identical or similar indicia relating the scaled happiness index associated with the use of each product. Alternatively, the communications may utilize distinctly different indicia and/or scales in order to concurrently provide the desired information to the shopper without necessarily encouraging a direct comparison. As an example, a communication relating to a first brand may comprise a first indicia relating the happiness index associated with the use of the first brand scaled from 1 to 5. Concurrently, a second communication may comprise a distinctly different second indicia relating the happiness index associated with use of a second brand scaled from 1 to 10. The respective communications may relate to the same emotional state or to different emotional states. The marketer may desire to communicate a first emotional state with a first brand and a second emotional state with a second brand. The choice of selected emotional state may depend upon the overall brand identity, the particular target market segment for the brand or other factors associated with the particular brands, such as the intended uses of the product.

The scale may be depicted directly by using numeric values, or symbolically, using a collection of indicia such as a depiction of 4 of 5 indicia highlighted or simply visible to indicate a value of four on a scale of 1 to 5.

In one embodiment the scaled emotional state communications may be provided for multiple products across different product categories. The communications may utilize similar or identical indicia and scale ranges to promote an association among the various product offerings. Alternatively, different indicia and/or different scales may be used to lessen any association associated with the use of the scaled communication across product categories.

In one embodiment, a package or product or service may provide one or more shopper communications which address multiple brand offerings within a category of products or services wherein the products or services may be considered as competitive offerings. The addressed multiple brand offerings may comprise products or services from different categories which may be unrelated; or, related to one another in a direct or synergistic product or service benefit, purpose or function. A mixture of both product and service offerings can be part of the shopper communications, e.g. at-home hair coloring or styling and professional salon hair coloring or styling; at-home car-washing and an mechanized car wash business; or, at-home clothes laundering and a laundering service.

A single scaled emotional state may be communicated across different product or service categories in an effort to provide a link associating or suggesting a commonality between product offerings. Alternatively, different scaled emotional states may be associated with each different product category. The selection of a particular scaled emotional state for communication may depend upon the product type and the intended uses of the product, the target market segments, and the brand identity among other product aspects. The different product category offerings may be provided under an umbrella brand name, or subnomen, or may be offered under different brand names or subnomen.

The emotional response of a shopper to packaging comprising the scaled emotional state may be measured using the methods described above. The measured response of the shopper may be used as input to marketing plans and to evaluate any effect from the use of the scaled emotional state.

In one embodiment the cortisol levels of a product user may be determined prior to, during and after product use. Cortisol levels are known to correlate to subject stress levels. An index may be developed to communicate the emotional state indicated by the cortisol level associated with the use of the product. The index may be scaled to afford a more convenient manner of communicating the stress level change. The scale may be any convenient rating. Exemplary scales range from 1 to 5, from 1 to 10, 1 to 100, and other ranges appropriate to the measured data. In this embodiment, the product may include a label comprising indicia which communicate the derived value associated with the product use.

In one prophetic embodiment, the same emotional state may be determined for each of two products. In this embodiment, a product claim expressing the measured difference in scaled emotional states may be made. As an example, the measured data could provide data to support a claim that the use of brand “A” yields a scaled emotional state which is twice as great as the scaled emotional state resulting from the use of brand “B”.

In one prophetic embodiment the measured data may support a claim which links the scaled emotional state to a particular product ingredient, feature; or, benefit or result of the use of the product or service.

In one prophetic embodiment, the data associated with a spectrum of products in a particular market category may be translated to a corresponding spectrum of scaled emotional states. In this embodiment, the spectrum of scaled emotional states may be conveyed in the shopper communication with each respective state associated with a point along an emotional state scale. In this manner, the shopper may be provided information enabling a product selection based upon the point along the scale which the shopper seeks to achieve. As an example, an array of body soap products may be found to yield scaled emotional states ranging from strongly relaxing to strongly stimulating. The scaled emotional states for each product may then be depicted together with a scale across the measured range. The shopper is thus provided with information regarding the relative positions of the respective products along a common emotional scale.

The emotional scale indicia can employ text, numbers, symbols, highlighting, etc to communicate to the shopper. The indicia can include imagery such as drawings, figures or photos of the outward observable appearance of a person associated with the emotional state or level of an emotional state. An example for this embodiment is the use of photos of either the face or body of a person in different levels of relaxation or stimulation. As examples of shopper communication venues, the shopper communication of this embodiment can be present on the package, in television, internet or print communications such as advertising; or, embodied within related marketing materials located within a physical retail store or internet store site where the product may be purchased.

The scaled emotional state for the bar soap embodiment may be derived during or after bar soap use from an identified group of product or service users including marketer-identified prospects and groups that share a common vocation or avocation; an individual mammal; one or more spokes-mammals. The emotional state can be derived from one or more individuals that physically-used the bar soap product, or are observers of the person or persons that physically used the bar soap product, or combination of physical users and observers. Multiple emotional states may be derived, such as before after use of the bar soap in order to measure and then communicate the difference or change in emotional state.

In one prophetic embodiment, the measured data may be referenced to a benchmark standard with which the shopper is familiar. As an example, the data may support a communication that the emotional state associated with the product's use may be related to a scaled amount of coffee consumption, i.e. one cup, two cups, three cups, and so on. As another example, the data may support a communication of the emotional state associated with the frequency of use of a product or service, such as how frequently one shampoos one's hair; how frequently one employs a car wash service of their automobile; or, how often one uses a product or device to clean a kitchen floor.

In one prophetic embodiment, data associated with product use for the benefit of a non-or low communicative target subject, such as a baby or a mammalian pet, may form the basis for the scaled emotional state. In this embodiment, the communication may provide the shopper with information regarding the emotional impact upon the target subject of the product's use.

As shown in FIG. 1, a package 100 includes indicia 110. Indicia 110 graphically illustrates a scaled emotional state value corresponding to a rating of four on a scale of zero to five.

As shown in FIG. 2, a shopper communication conveyed via a print advertising. The advertising 200, comprises an illustration 210, advertising copy 220, and indicia 230. Indicia 230 illustrate the relative scaled emotional state associated with the use of two respective products.

In one embodiment, the shopper communication provides indicia relating the scaled emotional state of at least two distinct brands. In this embodiment, the scaled emotional state associated with the use of each branded product or service is provided in a single communication for the purpose of enabling a shopper to utilize the relative scaled emotional state information in their brand selection process.

Although the present invention is not limited to consumer products falling within specific categories, a representative, non-limiting list of product categories includes antiperspirants, baby care, colognes, commercial products (including wholesale, industrial, and commercial market analogs to consumer-oriented consumer products), cosmetics, deodorants, dish care, feminine protection, hair care, hair color, health care, household cleaners, incontinence care, laundry, oral care, paper products, personal cleansing, disposable absorbent articles, pet health and nutrition, prescription drugs, prestige fragrances, skin care, snacks and beverages, special fabric care, shaving and other hair growth management products, small appliances, devices and batteries. A variety of product forms may fall within each of these product categories. Exemplary product forms and brands are described on The Procter & Gamble Company's website www.pg.com, and the linked sites found thereon. It is to be understood that consumer products that are part of product categories other than those listed above are also contemplated by the present invention, and that alternative product forms and brands other than those disclosed on the above-identified website are also encompassed by the present invention.

Exemplary products within the laundry category include detergents (including powder, liquid, tablet, and other forms), bleach, conditioners, softeners, anti-static products, and refreshers (including liquid refreshers and dryer sheets). Exemplary products within the oral care category include dentifrice, floss, toothbrushes (including manual and powered forms), mouth rinses, gum care products, tooth whitening products, and other tooth care products. Exemplary feminine protection products include pads, tampons, interlabial products, and pantiliners. Exemplary baby care products include diapers, wipes, baby bibs, baby change and bed mats, and foaming bathroom hand soap. Exemplary health care products include laxatives, fiber supplements, oral and topical analgesics, gastro-intestinal treatment products, respiratory and cough/cold products, heat delivery products, and water purification products. Exemplary incontinence care products include diapers, pads, and liners. Baby care, incontinence care and feminine protection products may be marketed for purposes of managing urinary and/or fecal incontinence; absorbing or containing bodily wastes; toilet training; and/or protecting skin. Exemplary paper products include toilet tissues, paper towels, and facial tissues. Exemplary hair care products include shampoos, conditioners (including rinse-off and leave-in forms), and styling aids. Exemplary household care products includes sweeper products, floor cleaning products, wood floor cleaners, antibacterial floor cleaners, fabric and air refreshers, and vehicle washing products. Skin care products include, but are not limited to, body washes, facial cleansers, hand lotions, moisturizers, conditioners, astringents, exfoliation products, microderm abrasion and peel products, skin rejuvenation products, anti-aging products, masks, UV protection products, and skin care puffs, wipes, discs, clothes, sheets, implements and devices (with or without skin care compositions).

The communication may be used with respect to services. Exemplary services include: car wash, dry cleaning, hair salons, human and pet beauty and grooming salons, laundry service, food and beverage services including coffee service, barber shops, carpet and floor cleaning and washing services, maid and janitorial services, as well as architectural decorating services and products.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shopper communication regarding a product or service, the communication comprising an indicia analogous to a scaled emotional state, or element thereof, wherein the emotional state or element thereof, is associated with use of the product or service.

2. The shopper communication of claim 1, wherein the communication is provided upon a product package, product label, or the product itself.

3. The shopper communication of claim 1, wherein the communication is provided as part of an advertisement for the product or service.

4. The shopper communication of claim 1, wherein the emotional state, or element thereof, is associated with the use of the product or service by a particular individual mammal.

5. The shopper communication of claim 1 comprising a second indicia analogous to a scaled emotional state, or element thereof, wherein the emotional state or element thereof, is associated with use of a second product or service.

6. The shopper communication according to claim 1, wherein the emotional state, or element thereof, is derived from an identified group of product or service users.

7. The shopper communication according to claim 6, wherein the identified group shares a common vocation or avocation.

8. The shopper communication according to claim 6, comprising an endorsement of the product or service by the group.

9. The shopper communication according to claim 1, comprising a visual or textual element associated with the emotional state, or element thereof.

10. The shopper communication according to claim 1, wherein the emotional state, or element thereof, is derived from an observer of the use of the product or service.

11. The shopper communication according to claim 1, wherein the indicia relates the relative emotional state, or element thereof, associated with use of the product or service along a predetermined scale.

12. A method of communicating information regarding an emotional state, or element thereof, associated with the use of a product or service, the method comprising steps of:
a) collecting data relating to a physiological state of the user of a product or service, or of an observer of the user,
b) associating the physiological state with an emotional state, or element thereof,
c) determining a value for the associated emotional state, or element thereof, on a derived scale of the emotional state, or element thereof, and
d) communicating the scaled emotional state, or element thereof, via an indicia in an advertisement, as part of the product itself, or as part of a product package.

13. The method according to claim 11, wherein the physiological change is associated with a property or function of the skin, or any of the circulatory, digestive, lymphatic, respiratory, reproductive, skeletal, muscular, excretory, endocrine, or nervous systems, including brain function, or paralanguage of a mammal, alone or in combination.

14. The method according to claim 12 wherein the indicia comprises a portion of the product package.

15. A product package comprising indicia analogous to a scaled emotional state, or element thereof, the scaled emotional state, or element thereof, derived from the use of the product.

16. The shopper communication of claim 15, wherein the emotional state, or element thereof, is associated with the use of the product or service by a particular individual mammal.

17. The shopper communication according to claim 15, wherein the emotional state, or element thereof, is derived from an identified group of product or service users.

18. The shopper communication according to claim 17, wherein the identified group shares a common vocation or avocation.

19. The shopper communication according to claim 15, comprising a visual or textual element associated with emotional state, or element thereof.

20. The shopper communication according to claim 15, wherein the emotional state, or element thereof, is derived from a physiological response of an observer of the use of the product or service.
